(19) United States
(12) Patent Application Publication
(10) Pub. No.: US 2017/0099392 A1
(43) Pub. Date: Apr. 6, 2017

(54) DIAL-UP COMMUNICATION DEVICE, METHOD, AND COMPUTER-READABLE MEDIUM THAT PERFORM DIAL-UP COMMUNICATION

(71) Applicant: Kenichi WATANABE, Kanagawa (JP)

(72) Inventor: Kenichi WATANABE, Kanagawa (JP)

(21) Appl. No.: 15/282,004

(22) Filed: Sep. 30, 2016

(30) Foreign Application Priority Data
Oct. 1, 2015 (JP) 2015-196155

(51) Int. Cl. H04M 11/08; H04N 1/00

(52) U.S. Cl. CPC H04M 11/08; H04N 1/00519; H04N 1/00214; H04N 1/00411; H04N 2201/0094; H04N 2201/0093

(57) ABSTRACT

A dial-up communication device, method, and computer-readable medium, the dial-up communication device including a first device that includes first circuitry configured to control performance of dial-up communication and acquire signal information of a received signal during the dial-up communication, and a second device that is separate from the first device, the second device including a speaker and second circuitry, the second circuitry being configured to receive the acquired signal information from the first device, determine sound information based on the acquired signal information, and control outputting of a sound, via the speaker, based on the determined sound information.

### CROSS-REFERENCE TO RELATED APPLICATION(S)

The present application is based upon and claims the benefit of priority from Japanese Application No. 2015-196155, filed Oct. 1, 2015, the entire contents of which are hereby incorporated by reference.

### BACKGROUND

1. Field

The present disclosure relates to a dial-up communication device, and method and computer program product for controlling a dial-up communication device.

2. Description of the Related Art

In a facsimile (FAX) device or a device on which a facsimile is mounted, it is common for a speaker to be mounted that outputs a line sound in order for a user to be able to recognize transmitting and receiving of the FAX.

This speaker is mounted on a part of a device that transmits and receives the FAX for the purpose of outputting a sound based on the signal generated in response to the protocol related to transmitting and receiving of the FAX.

On the other hand, in a Multi-Function Peripheral (MFP) having plural types of functions such as a scanner, a printer, and a FAX etc., in order to enhance the user experience, a beep or an alarm sound will be output from a speaker that is mounted on an operation panel, which is used to operate the device by a user. As a result, two speakers are mounted on the MFP.

For that reason, for example, it is desirable that e two speakers be integrated into one speaker mounted on the operation panel. In this case, the sound generated in response to transmitting and receiving of a FAX needs to be transferred to the operation panel and output on the operation panel.

Further, an encoding of sound data, an identifying by an identifier, and a decoding of the identified encoding data. in the sound output has been proposed (for example, refer to Japanese Laid-Open Patent Publication No. JP 2014-155114).

As mentioned above, it is possible to perform sound outputting from the integrated speaker mounted on the operating panel by using the technology disclosed in JP 2014-155113. However, in that case, at first, the sound signal is encoded by the transmitting and receiving part of the FAX. After that, the sound signal is transferred to the operating panel. Finally, the sound signal is decoded and output as a sound. As a result, a time lag occurs between generating the sound signal and outputting the sound via the operating panel. To decrease the time lag, it is necessary to provide a special transmitting path. However, in that case, the benefits of simplifying the device structure by integrating the two speakers into one would be lost.

Note that such problem does not only occur in a FAX device. In fact, the same problem occurs in a device that uses dial-up communication (and does not have a speaker mounted on a unit that communicates via dial-up) when it outputs a sound in response to a communication signal.

Therefore, there is a need for a dial-up communication device that eliminates delay time for the sound output and that has a simplified structure in the case of outputting sound in response to dial-up communication from a speaker mounted on a unit that is different from a dial-up communication unit.

### SUMMARY

According to an embodiment, there is provided a dial-up communication device including a first device that includes first circuitry configured to control performance of dial-up communication and acquire signal information of a received signal during the dial-up communication, and a second device that is separate from the first device, the second device including a speaker and second circuitry, the second circuitry being configured to receive the acquired signal information from the first device, determine sound information based on the acquired signal information, and control outputting of a sound, via the speaker, based on the determined sound information.

According to the present disclosure, it is possible to eliminate the delay time and to simplify the structure for a device that outputs a sound in response to the dial-up communication from a speaker mounted on the unit different from the dial-up communication unit.

### BRIEF DESCRIPTION OF THE DRAWINGS

FIG. 1 is a block diagram of an overall configuration of an MFP according to an embodiment;

FIG. 2 is a block diagram of a hardware structure of each part which configures an MFP;

FIG. 3 is a diagram showing signals exchanged by a protocol in a dial-up communication;

FIG. 4 is a diagram of exemplary information stored in the sound information storage;

FIG. 5 is a sequence diagram of the operation of the MFP;

FIG. 6 is a sequence diagram of the operation of the MFP;

FIG. 7 is a sequence diagram of the operation of the MFP; and

FIG. 8 is a block diagram of an overall configuration of an MFP according to an embodiment.

### DETAILED DESCRIPTION

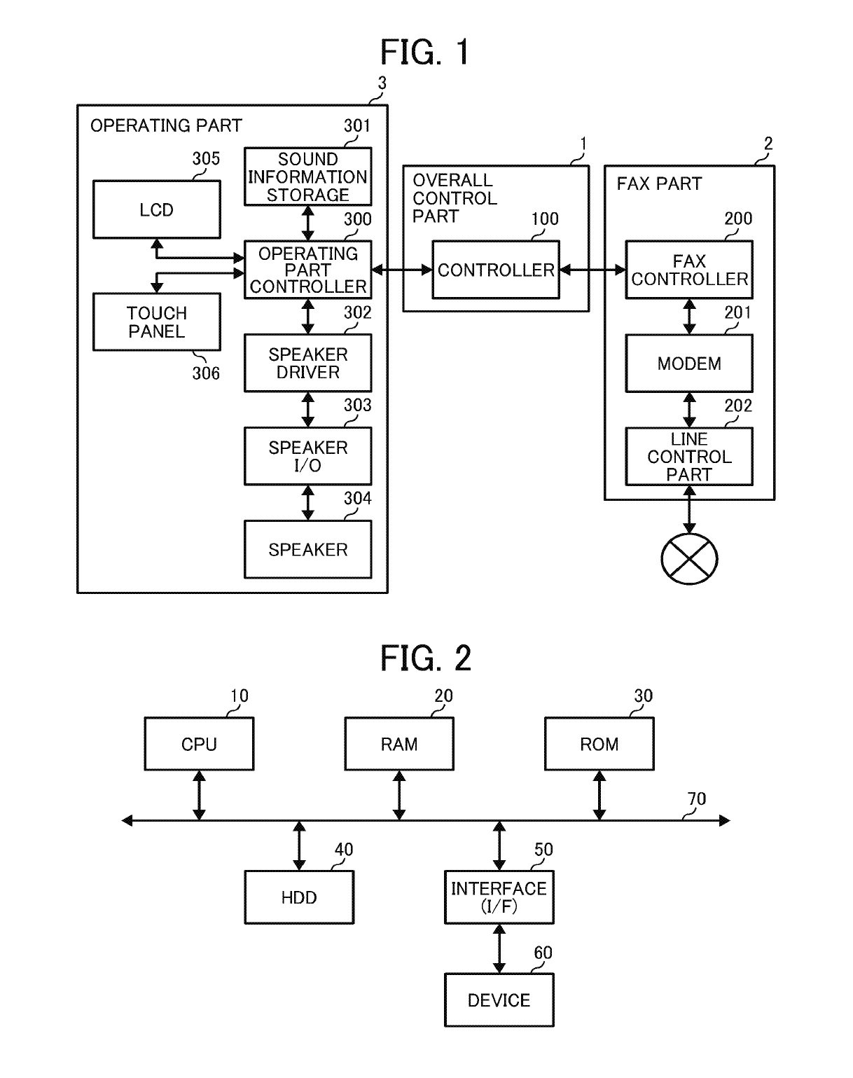

The characteristics of the present embodiment are explained in detail below. In the present embodiment, an MFP equipped with a FAX device is discussed as an example. One of the features of such MFP is outputting sound related to a dial-up communication from a speaker mounted on another part of the MFP, instead of a speaker mounted on the FAX part. FIG. 1 is a block diagram of an overall configuration of an image forming system according to an embodiment.

As shown in FIG. 1, the MFP related to an embodiment of the present disclosure includes an overall control part 1 that controls the entire MFP, a FAX part 2 that operates a facsimile function, and an operating part 3 (operating panel) that is operated by a user. In the overall control part 1, a controller 100 controls the MFP, which communicates information between the FAX part 2 and the operating part 3. Note that the FAX part 2 and the operating part 3 are devices that are separate from each other (i.e., electrically separate, at a separate physical distance, etc.).

FAX part 2 includes FAX controller 200, modem 201, and tine control part 202. FAX controller 200 controls FAX part 2 and communicates information with a controller 100 in the overall control part 1. The modem 201 modulates and demodulates signals related to a facsimile communication. Line control part 202 performs A/D conversion of received data and D/A conversion of transmitted data, and communicates with the device elated to the facsimile communication via a telephone line.

Conventionally, the sound in response to an analog signal generated in the facsimile communication was output from a speaker connected to the line control part 202. As a result, a user would be able to recognize (by hearing a sound) that a. facsimile communication is being performed. However, the MFP of the present embodiment simplifies the structure by omitting a speaker from the FAX part 2, and outputs the sound related to the facsimile communication from the speaker mounted on the operating part 3.

The operating part 3 related to the present embodiment includes operating part controller 300, sound information storage 301, speaker driver 302, speaker I/O 303, speaker 304, LCD 305, and touch panel 306. The operating part controller 300 controls the operating part 3 and communicates information with controller 100 of the overall control part 1.

Sound information storage 301 is a storage device (memory) that stores sound information corresponding to an analog signal (in response to the facsimile communication) with an identifier in the line control part 202. The speaker driver 302 operates sound in accordance with the control of the operating part controller 300. The speaker I/O 303 is an interface that connects to the speaker 304 in the operating part 3. The speaker I/O inputs the signal that is output by the speaker driver 302 into the speaker 304.

LCD 305 is a display that displays information to a user. Touch panel 306 is used by a user to input information by touch operation. The LCD 305 and the touch panel 306 may be integrated/part of a single device.

Next, the hardware structure of the MET of the embodiment is explained with reference to FIG. 2. FIG. 2 is a block diagram illustrating a configuration of the overall control part 1, the FAX part 2, and the operating part 3, shown in FIG. 1.

As shown in FIG. 2, the overall control part 1, the FAX part 2, and the operating part 3 (which are elements of the MFP) have the same structure as an information processing apparatus (such as a general PC (Personal Computer) or a server). That is, each part may include CPU (Central Processing Unit) 10, RAM (Random Access Memory) 20, ROM (Read Only Memory) 30, HDD (Hard Disk Drive) 40, and interface (tin 50, which are connected to each other via a bus 70. Further, interface (I/F) 50 is connected to device 60.

The CPU 10 controls each part of overall control part 1. RAM 20 is a volatile recording media available to read or write data fast, and is used as a work area of the CPU. ROM 30 is a non-volatile read-only memory in which programs such as a firmware are stored. HDD 40 is a non-volatile recording media available to read or write data in which an OS (Operating System), various control programs, and application programs are stored. Further, the non-volatile recording media may be used as an SSD (Solid State Drive and an NV-RAM (Non-Volatile RAM) etc., instead of HDD 40.

The I/F 50 connects bus 70 and various hardware. The device 60 is a hardware device that is connected to the bus 70 via the I/F 50. Note that the device 60 is external to/outside of the FAX part 2. Further, note that the device 60 is external to/outside of the operating part 3.

In such structure, a software control part is configured by an operation of the CPU 10 in accordance with a program stored in the ROM 30, the HDD 40, and a recording media or an optical disk (not shown) etc. to the RAM 20. The software control part realizes the functions of the overall control part 1, the FAX part 2, and the operating part 3 by a combination with the hardware control part (i.e., hardware/software combination).

In the MFP of the present disclosure, the FAX part 2 does not have a speaker. The sound produced in response to a signal related to the facsimile communication is output from the speaker 304 mounted on the operating part 3. According to a feature of the embodiment, the operating part 3 outputs the sound in response to the signal generated in the FAX part 2 without a time delay.

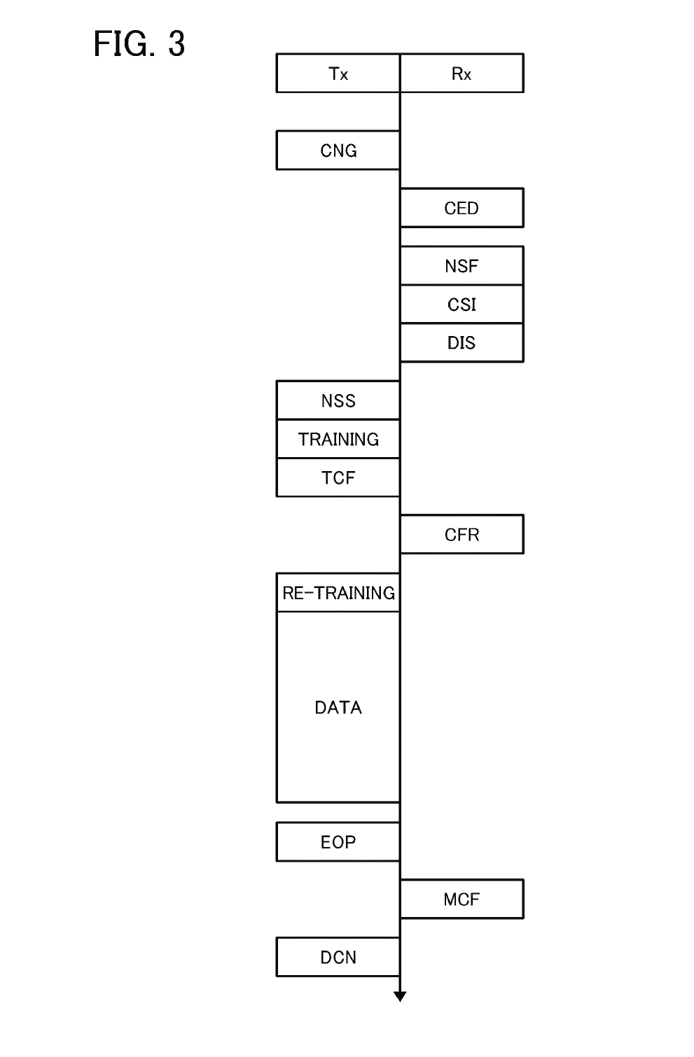

Next, the sound that occurs as a result of the facsimile communication protocol of the present embodiment is explained with reference to FIG. 3. FIG. 3 is a diagram that shows the Lime sequence for an example of an analog signal that is sent by transmitting and receiving of a dial-up signal. “CNG” is a signal to notify automatic transmission to the receiving side. “CED” is a signal to notify the receiving status from the receiving side to the transmitting side.

“NSF” is a signal to notify a function of the apparatus (that sends the signal) to the transmitting side at the time of receipt. “CSI” is a signal transmitted from the FAX part 2 to the transmitting side to notify the transmitting side that the FAX part 2 received data. “DIS” is a signal to notify a function of the apparatus to the transmitting side at the time of receipt. “NSS” is a signal to notify a transmitting condition to the receiving side at the time of transmitting. “Training” is a signal to notify a modem at the receiving side to prepare training. “TCF” is a signal to check modem training.

“CFR” is a response signal to notify success of the modem training to the transmitting side. “Re-training” is a signal to notify the modem at the receiving side to prepare real transmitting data. “Data” is real image data to be transmitted or received in the facsimile communication. “EOP” is a signal to notify completion of transmission of the last-page information to the receiving side.

“MCF” is a response signal to notify that image information and an instruction are correctly received after a message to the transmitting side. “DCN” is a signal to notify that a line is changed from facsimile to telephone. Note that by such sequence of signals, the facsimile communication is carried out.

Signals such as “CNG”, “CED”, etc. are expressed by a predetermined frequency. Conventionally, each frequency signal is output as sound from a speaker connected to the line control part 202. On the contrary, in the MFP of the present embodiment, each protocol identifier that shows each of the generated signals is notified to the operating part 3 (as shown in FIG. 3), and the sound information stored in the sound information storage 301 is read out in response to the protocol identifier. By this process, the sound is output from the speaker 304 of the operating part 3 without a delay in time, after generating the signal related to the facsimile communication in the FAX part 2.

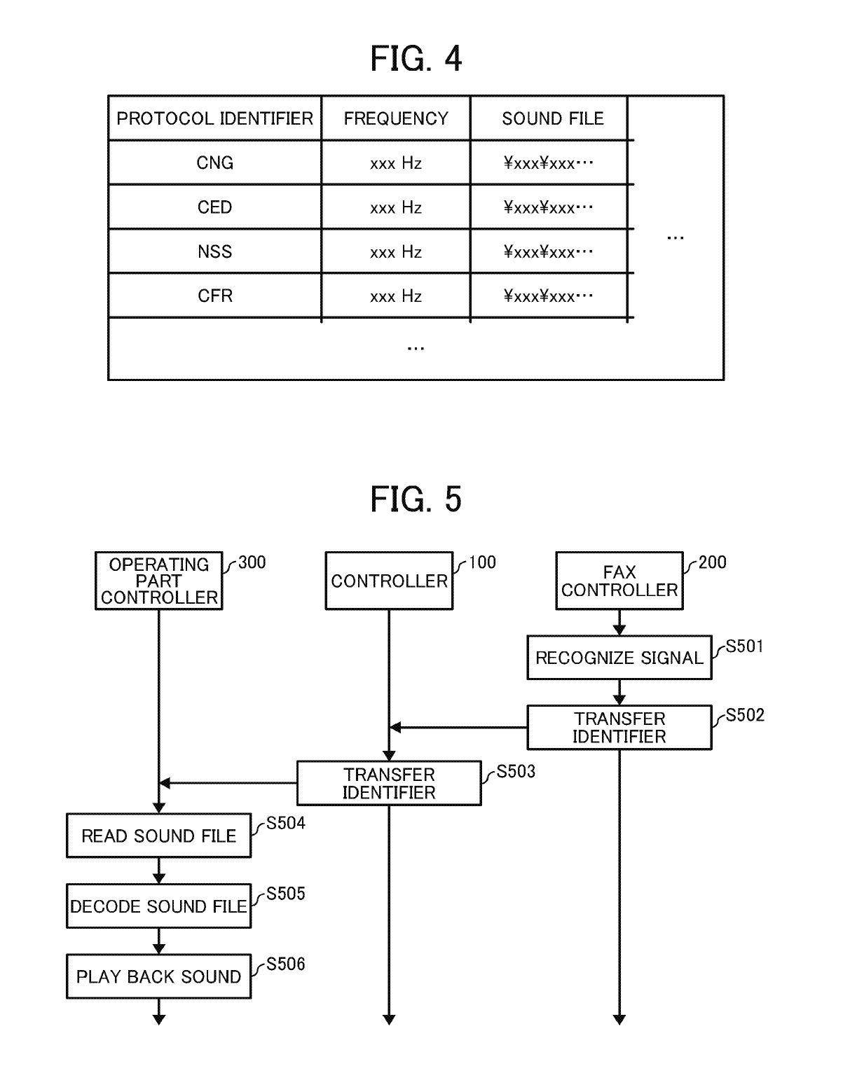

FIG. 4 is a diagram that shows information stored in the sound information storage 301. As shown in FIG. 4, the sound information storage 301 stores “protocol identifier”, “frequency”, and “sound file” in association with each other. The “protocol identifier” is an identifier that indicates each signal (for example, “CNG”, “GED”, etc. discussed with reference to FIG. 3). The “frequency” is a frequency of each signal. The “sound file” is sound information (a beep sound, an alarm sound, etc.) that is output from the speaker 304 in response to the frequency of each signal.

Next, the behavior of the MFP is explained with reference to FIG. 5. When a facsimile communication is performed by transmitting or receiving of data, the FAX controller 200 recognizes a signal that is generated in the line control part 202 via the modem 201 shown in FIG. 5 (Step S501). The FAX controller 200 transfers an identifier that indicates a signal recognized at Step 5501 to the controller 100 (Step S502).

The controller 100 then transfers the identifier to the operating part controller 300 (Step S503). By this process, the signal related to the facsimile communication generated in the FAX part 2 is notified to the operating part 3. In this way, in the example of FIG, 5, the FAX controller 200, the controller 100, and the operating part controller 300 act as a signal acquisition part conjunction with each other.

The operating part controller 300, which receives the identifier from the controller 100, refers to the sound information storage 301 in response to the notified identifier, and reads a sound file related to the identifier (Step S504). In Step S504, the operating part controller 300 acts as a sound information acquisition part. Since the read sound file stored in the sound information storage 301 is encoded, the operating part controller 300 decodes the read sound file (Step S505).

When the operating part controller 300 decodes the sound file, the operating part controller 300 outputs a sound to the speaker 304 by controlling the speaker driver 302 (Step S506). At Step S505 and Step S506, the operating part controller 300 acts as a sound output controller. By such processing, a process of the MFP of the present embodiment is complete.

The identifier that is transferred at Step S502 and Step S503 is information configured of several bits, so it takes very little time to transmit. The sound file is comprised of short sound data. For this reason, it takes very little time to read or decode this sound data. Therefore, it is possible to complete the operation almost without having any time delay from Step S501 to Step S506.

In FIG. 5, the characteristics of the present embodiment were explained as an example of a case in which the decoded sound file is stored in the sound information storage 301. However, as mentioned above, the sound file is short sound data, for example, made up of dozens of kilobytes. For this reason, it may be necessary for capacity compressing by decoding. Therefore, raw data that does not require decoding may be stored as a sound file in the sound information storage 301. In that case, the process of Step S505 may be omitted.

In FIG. 5, the characteristics of the present embodiment were explained as an example of a case in which the FAX controller 200 transfers the identifier of the signal in response to signal recognition. In this case, signal recognition takes place based on a frequency of an analog signal generated in the line control part 202. Therefore, it is possible to recognize the signal b , the frequency, and the FAX controller 200 may transfer data that shows the frequency instead of the identifier of the signal. In this case, as shown in FIG. 4, the operating part controller 300 reads a sound file related to the frequency based on the notified frequency.

Further, the sound which is output by the facsimile communication is produced as a sound in response to the frequency of the analog signal exchanged by a communication. In other words, if the frequency of the signal can be determined, sound data may be generated using the frequency instead of using the stored sound file as previously discussed). Such example is described with reference to FIG. 6.

As shown in FIG. 6, the FAX controller 200 recognizes the frequency of the signal generated b the line control part 202 via the modem 201 (Step S601). The FAX controller 200 transfers frequency information recognized at Step S601 to the controller 100 (Step S602).

The controller 100, to which the frequency was transferred by the FAX controller 200, transfers the frequency to the operating pa controller 300 (Step S603), By this process, the frequency related to the facsimile communication which was generated by the FAX part 2 is transferred to the operating part 3.

The operating part controller 300, to which the frequency was transferred from the controller 100, generates sound data based on the transferred frequency (Step S604). The process at Step S604 is a process to generate the wave data of the notified frequency as sound data. When the operating part controller 300 generates the sound data, the operating part controller 300 causes the speaker 304 to output a sound by controlling the speaker driver 302 (Step S605).

According to the process shown in FIG. 6, it is possible to further simplify the structure of the apparatus because it is unnecessary to store the sound file in advance in the operating part 3. In addition, it is also possible to resolve the e delay from the generation of the facsimile communication to the sound output because it is unnecessary to perform encoding/decoding of sound data or to read the sound data.

It should be noted that the aforementioned embodiment is discussed as an example in which the FAX controller 200 transfers the frequency. However, as discussed with reference to FIG. 4, the identifier of the signal is associated with the frequency in the sound information storage 301. Therefore, even in the case that the identifier of the signal was notified to the operating part controller 300, it is also possible to perform the processing of Step S604 in FIG. 6 by recognizing the frequency of the signal with reference to the sound information storage 301, based on the previously described case.

In addition, the embodiment described above discusses that frequency information is notified to the operating part controller 300 via the controller 100 in terms of the recognition of the signal by the FA..X controller 200. However, the FAX controller 200 operates under the control of the controller 100. Therefore, depending on the structure of the apparatus, the controller 100 may monitor the operating conditions of the FAX controller 200.

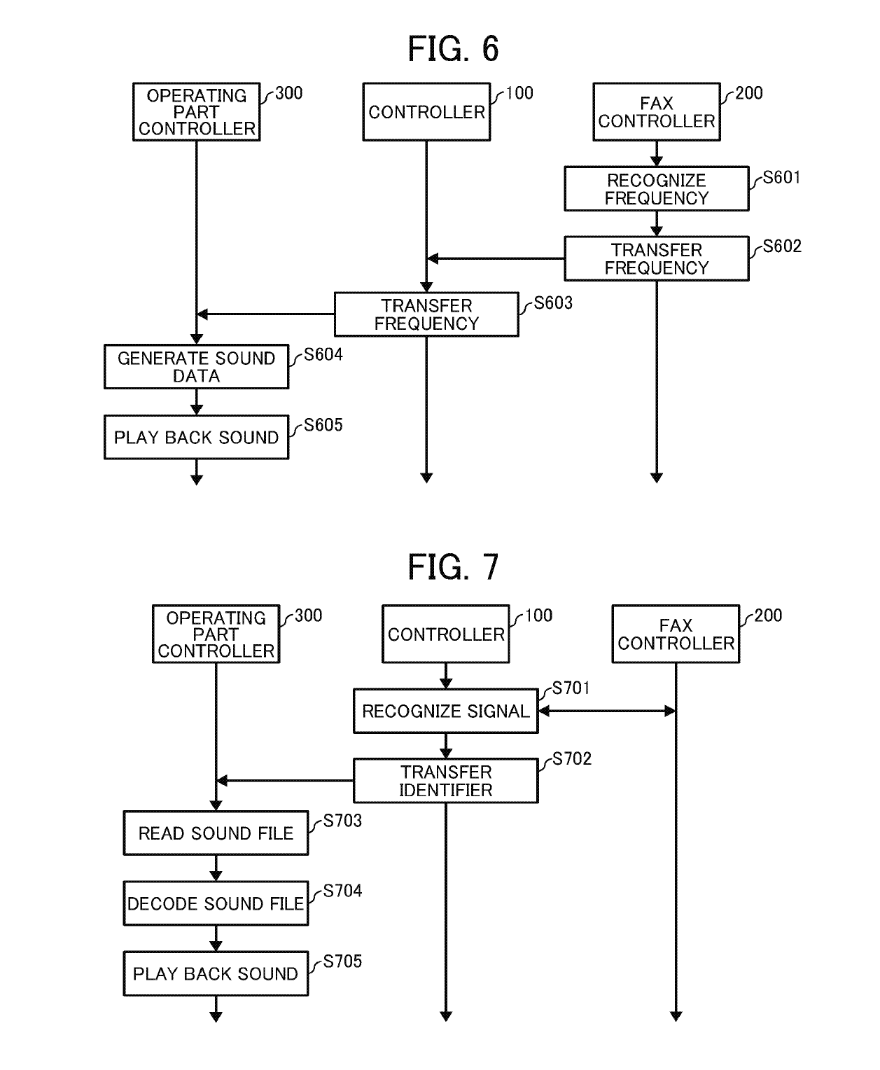

In such case, it is unnecessary to notify the frequency information from the FAX controller 200 to the controller 100, and it is possible to perform the processing based on the monitoring performed by the controller 100. Such an embodiment is discussed with reference to FIG. 7. As shown in FIG. 7, the controller 100 monitors the behavior of the FAX controller 200 and recognizes the signal in response to the facsimile communication generated in the FAX part 2 (Step S701). Next, the controller 100 transfers the identifier of the signal to the operating part controller 300 (Step S702).

The operating part controller 300, to which the identifier of the signal was transferred at Step S702, performs the same processing as performed in Step S504 to Step S506 shown in FIG. 5 (Step S703-Step S705). By this process, it is possible to obtain the same advantage as the process of FIG. 5. It should be noted that, as explained in FIG. 6, it is possible for the controller 100 to notify the operating part controller 300 by recognizing the frequency instead of the identifier of the signal.

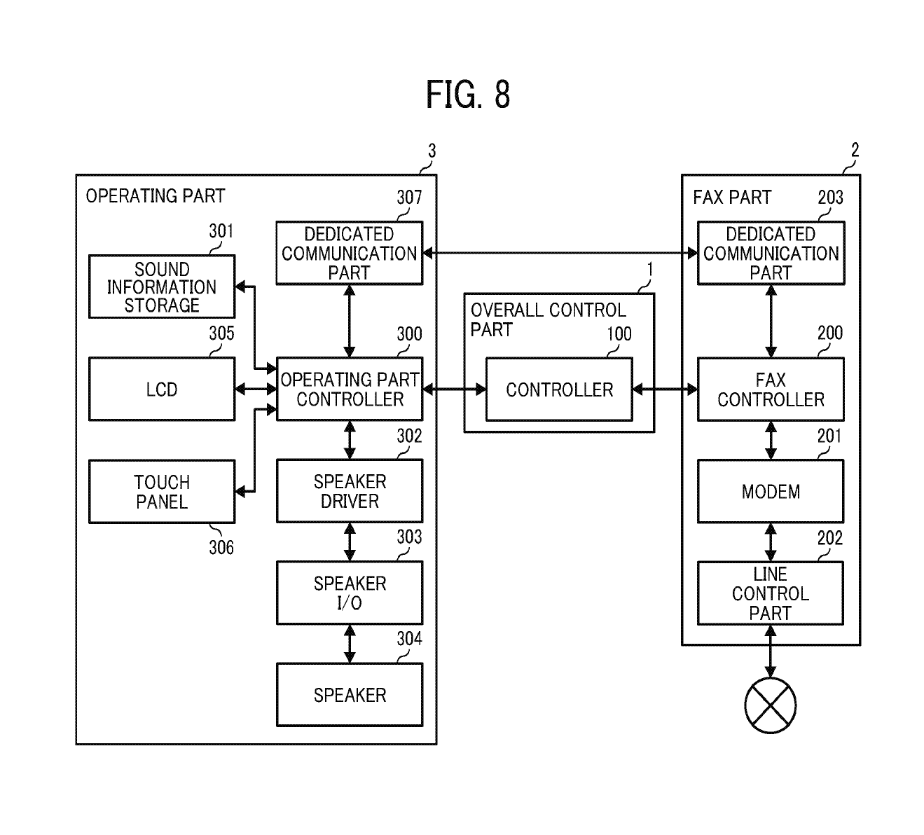

As described above, the controller 100 directs information between the FAX controller 200 and operating part controller 300. On the contrary, if a direct path that passes the information between the FAX part 2 and the operating part 3 exists, it is unnecessary for the controller 100 to direct information between the FAX controller 200 and operating part controller 300. Such an example is shown with reference to FIG. 8.

In the example shown in FIG. 8, the FAX part 2 includes the dedicated communication part 203, and the operating part 3 includes the dedicated communication part 307. In the example of FIG. 8, it is possible for the FAX part 2 and the operating part 3 to exchange information directly via the exchange information 203 and the dedicated communication part 307. The aforementioned information includes the signal information the sound information.

By this configuration, it is possible to transmit the information from the FAX controller 200 to the operating part controller 300 without intervention of the controller 100, as discussed above with reference to FIG, 5 or FIG. 6. In this case, the FAX controller 200 and the operating part controller 300 act as the signal acquisition part in conjunction with each other via the dedicated communication part 203 and the dedicated communication part 307. As a result, it is possible to resolve the time delay of outputting the sound. It should be noted that the dedicated communication part 203 and the dedicated communication part 307 may communicate via wired or wireless communication. Further, it should be noted that the present embodiment(s) apply not only to facsimile, but also to any other device (such as a computer) with dial-up capabilities.

As described herein, it is possible to eliminate the time delay and to simplify the structure of the device in the case of outputting the sound in response to dial-up communication from a speaker mounted on a device that is different from the dial-up communication device. Further, each of the functions of the described embodiments may be implemented by one or more processing circuits. A processing circuit includes a programmed processor (for example, CPU 10), as a processor includes circuitry. A processing circuit may also include devices such as an application specific integrated circuit (ASIC) and conventional circuit components arranged to perform the recited functions.

What is claimed is:

1. A dial-up communication device, comprising:
a first device that includes first circuitry configured to control performance of dial-up communication and acquire signal information of a received signal during the dial-up communication; and
a second device that is separate from the first device, the second device including a speaker and second circuitry, the second circuitry being configured to receive the acquired signal information from the first device, determine sound information based on the acquired signal information, and control outputting of a sound, via the speaker, based on the determined sound information.

2. The dial-up communication device according to claim 1, further comprising:
a memory that stores the signal information in association with the sound information, wherein
the second circuitry is configured to determine the sound information based on the signal information by accessing the memory.

3. The dial-up communication device according to claim 1, wherein
the first circuitry is father configured to acquire, as the signal information, an identifier identifying the received signal.

4. The dial-up communication device according to claim 1, wherein
the first circuitry is further configured to acquire, as the signal information, a frequency of the received signal.

5. The dial-up communication device according to claim 1, wherein
the first circuitry is further configured to acquire, as the signal information, a frequency of the received signal, and
the second circuitry is further configured to determine the sound information to be output in response to the received signal by generating wave data based on the acquired frequency.

6. A control method performed in a dial-up communication device that includes a first device configured to perform dial-up communication, and a second device that includes a speaker, the second device being separate from the first device, the control method comprising:
acquiring, by first circuitry of the first device, signal information f a received signal during the dial-up communication;
receiving, by second circuitry of the second device, which is separate from the first device, the acquired signal information from the first device;
determining, by the second circuitry of the second device, sound information based on the acquired signal information; and
controlling, by the second circuitry of the second device, outputting of a sound, via the speaker, based on the determined sound information.

7. A non-transitory computer-readable medium including computer executable instructions, wherein the instructions, when executed by a computer that includes a first device configured to perform dial-up communication, and a second device that includes a speaker, the second device being separate from the first device, cause the computer to perform a method, the method comp
acquiring, by the first device, signal information of a received signal during the dial-up communication;
receiving, by the second device, which is separate from the first device, the acquired signal information from the first device;
determining, by the second device, sound information based on the acquired signal information; and
controlling, by the second device, outputting of a sound, via the speaker, based on the determined sound information.
